(19) United States
(12) Patent Application Publication
(10) Pub. No.: US 2023/0068393 A1
(43) Pub. Date: Mar. 2, 2023

(54) System and Method for a Vehicle With a Driver Assistance System for an Automatic Drive, Corresponding Vehicle, and Storage Medium

(71) Applicant: Bayerische Motoren Werke Aktiengesellschaft, Muenchen (DE)

(72) Inventors: Gunter HANNIG, Fuerstenfeldbruck (DE); Christina KURPIERS, Moosburg (DE); Felix LAUBER, Muenchen (DE); Frederik PLATTEN, Muenchen (DE)

(21) Appl. No.: 17/796,710

(22) PCT Filed: Dec. 14, 2020
(86) PCT No.: PCT/EP2020/085979

§ 371 Date: Aug. 1, 2022

(30) Foreign Application Priority Data
Feb. 7, 2020 (DE) 10 2020 103 200.5

(51) Int. Cl. B60N 2/02

(52) U.S. Cl. CPC B60N 2/0248; B60W 60/0053

(57) ABSTRACT

A system for a vehicle with a drive assistance system for an automatic drive includes an adjustment module for an electric seat setting of a driver seat and a control module that is designed such that, during an automatic drive operation of the vehicle, a seat setting of the vehicle seat is kept in a range which is suitable for allowing the driver to assume guidance of the vehicle.

### BACKGROUND AND SUMMARY

The present disclosure relates to a system for a vehicle equipped with a driving assistance system, a vehicle equipped with such a system, a method for the vehicle equipped with the driving assistance system for an automatic drive, and a storage medium for carrying out the method. In particular, this disclosure relates to an improvement in the safety of a driving assistance system for an automatic drive operation.

Driving assistance systems for automatic driving are becoming increasingly important. Automatic driving can be performed with different levels of automation. Examples of levels of automation are an assisted, partially automated, highly automated or fully automated driving mode. These levels of automation have been defined by the German Federal Highway Research Institute (BASt) (see the BASt publication “Forschung kompakt [Research digest]”, issue November/2012). For example, the vehicles with level 4 travel fully autonomously in urban operation.

During highly automated driving, the driver no longer has to monitor the driving process, but can theoretically pursue any unrelated activity. One limitation of this is that the driver must be able to assume control of the vehicle again safely within a few seconds at all times.

It is an object of this disclosure to provide a system for a vehicle equipped with a driving assistance system for an automatic drive, a vehicle equipped with such a system, a method for a vehicle equipped with a driving assistance system for an automatic drive, and a storage medium for carrying out the method, all of which can ensure that a driver can assume control of the vehicle at any time. In particular, one object of this disclosure is to improve the safety of a driving assistance system for automatic driving.

This object is achieved by the subject matter of the independent claims. Advantageous embodiments are specified in the dependent claims.

According to an independent aspect of this disclosure, a system for a vehicle equipped with a driving assistance system for an automatic drive is specified. The system comprises an adjustment module for an electrical seat adjustment of a driver's seat; and a control module which is configured to maintain a seat setting of the driver's seat in a range, or limit it to a range, that is suitable for allowing the driver to assume control of the vehicle.

According to the invention, the system ensures that the seat setting of the driver's seat remains in a safe range which allows the driver to assume control, or does not impede it or even prevent it. In one example, the system can issue an alert to the driver if the driver repositions the driver's seat and reaches a limit of the safe range. In addition or alternatively, the system can limit a (possible) seat setting to the safe range, so that the driver is not able to move the driver's seat out of the safe range.

This prevents the driver, for example, from moving their seat during highly automated driving to a position that is no longer ideally suited to allowing the driver to reach the steering wheel or the vehicle pedals. Thus, an ability to assume control is maintained. In addition, the option of simply locking the seat adjustment during highly automated driving is not used, thus avoiding a safety risk. By adjusting the seat during or (shortly) before the activation of highly automated driving, a simple locking would deprive the driver of the possibility of moving into a position with the best possible readiness to assume control.

Preferably, all seats except the driver's seat, such as the front passenger seat, operate without restriction, for example in the same way as in manual driving (or Level-1 or -2 systems). All the functions of the driver's seat which are not intended to impede the driver's ability to assume control may also function without restriction in some embodiments.

Preferably, the range which is suitable for allowing the driver to assume control of the vehicle is defined in such a way that a steering wheel and pedals can be reached by the driver.

In particular, the (safe) range can be appropriately specified taking one or more aspects into account. The aspects may include, but are not limited to, a vehicle type, a seat type, a vehicle-specific relative position between the seat and a steering wheel, and a vehicle-specific relative position between the seat and pedals. For example, the range can also be defined by taking empirical observations and/or experience into account.

The range of permitted seat settings can be defined for at least one component of the seat settings. The at least one component of the seat settings can be selected from the group comprising or consisting of a longitudinal position, a height position, and a backrest position (tilt).

The longitudinal position is defined along the direction of travel of the vehicle and/or based on a distance between the driver's seat and the steering wheel. The height position is defined in the vertical direction. The backrest position is defined as an inclination with respect to the vertical (or horizontal). The term “horizontal” is to be understood in contrast to “vertical”. The vertical direction can be essentially parallel to the force of gravity.

In a first example, the range is given by only one component, such as the longitudinal position of the driver's seat. In other words, the range can be defined in such a way that a specific longitudinal position of the driver's seat indicates the limit of the range. The specified longitudinal position may correspond to a maximum distance between the driver and the steering wheel (and/or the pedals) at which the driver can safely assume control of the vehicle.

In a second example, the range is given by two or more components, such as the longitudinal position and/or the height position and/or the backrest position. In other words, for each component a sub-range of possible/permitted settings may be given, which together form the range of permitted seat settings.

The sub-ranges can be defined independently or depending on one another. In an example with dependent sub-ranges, the sub-range of the longitudinal position can be smaller, the more inclined the backrest position. Similarly, the more straight the backrest position, the greater the sub-range of the longitudinal position can be. This ensures that the driver can grip the steering wheel with their hands at any time.

Preferably, the control module is configured to issue an acoustic and/or visual warning if the seat setting of the driver's seat approaches an (outer) limit of the range and/or reaches the (outer) limit. In this warning, the driver is informed about the concept of the ability to assume control, for example by means of a text and an explanatory graphic, using the example of the ability to reach the steering wheel and pedals.

The vehicle may comprise at least one optical output unit and/or at least one loudspeaker unit to generate the warning. For example, the optical output unit can be a display device, such as a display of an infotainment system. Typically, the display is installed in or on the dashboard of the vehicle. The display can be a head-unit, for example. In some embodiments, the display is an LCD display, a plasma display or an OLED display.

In addition or alternatively, the control module is configured to control the adjustment module during the automatic drive operation of the vehicle in such a way that the seat setting of the driver's seat beyond the range is not possible. In other words, a (possible) seat setting can be limited to the safe range, so that the driver is unable to move the driver's seat beyond the safe range. While the warning only instructs the driver not to adjust the seat beyond the safe range (but the driver can still do so in case of doubt), by actively limiting the seat setting the control module can deprive the driver of the ability to move the seat out of the safe range.

Preferably, the control module is configured to maintain the seat setting of the driver's seat in the range during the automatic drive operation of the vehicle if the seat setting reaches a threshold or approaches the threshold. For example, the control module can be configured to maintain the driver's seat setting in the range during the automatic drive operation of the vehicle when the seat position reaches a specified threshold in at least one spatial direction (e.g. horizontally, i.e., corresponding to the longitudinal position) or approaches the specified threshold. For example, the specified threshold value can indicate a maximum permissible (longitudinal) distance between the driver's seat and the steering wheel and/or the pedals.

For example, all functions that are designed to affect the driver's ability to assume control, i.e. all functions that can theoretically cause a change in the distance between the driver's feet and the pedals or between the driver's hands and the steering wheel, will result in a warning and/or an active restriction of the driver's ability to adjust the seat setting when a threshold value is reached (threshold value can also be 0).

The threshold can be a relative and/or variable threshold. In particular, the threshold can be set with reference to the driver. For example, the driver can be detected by means of an interior sensor system such as an interior camera. Based on the data collected, for example, the size of the driver, an arm length, a foot length etc. can be determined and, based on this, the threshold can be defined relatively and/or variably, i.e. individually for the driver.

Alternatively, the threshold can be a fixed threshold. In other words, the threshold can be independent of the individual driver. For example, once the longitudinal position of the driver's seat (x-position) is adjusted beyond a certain value relating to a distance from the driver's seat to the steering wheel, the system can become active and issue the warning to the driver and/or restrict the adjustment options of the driver's seat.

The adjustment module can preferably be operated by a user to carry out the electrical seat adjustment of the driver's seat. For example, the adjustment module may comprise at least one control element (e.g., on the seat itself, in the door or in the center console), which when operated sets at least one motor in motion that moves the seat in the desired direction.

According to another aspect of the present disclosure, a vehicle, in particular a motor vehicle, is specified. The vehicle comprises the system in accordance with the embodiments of this disclosure.

The term “vehicle” includes cars, trucks, buses, motor homes, motorcycles, etc., which are used for transporting people, goods, etc. In particular, the term includes motor vehicles for passenger transport.

The vehicle comprises a driving assistance system for automatic driving. The term “automatic driving” can be understood for the purposes of this document to mean driving with automatic longitudinal or lateral guidance, or autonomous driving with automatic longitudinal and lateral guidance. Automatic driving can consist, for example, of driving for an extended period on the freeway or time-limited driving during parking or maneuvering. The term “automatic driving” covers automated driving with any degree of automation. Examples of degrees of automation are an assisted, partially automated, highly automated or fully automated driving mode. These levels of automation have been defined by the German Federal Highway Research Institute (BASt) (see BASt publication “Forschung kompakt [Research digest]”, issue November/2012).

During assisted driving, the driver performs the longitudinal or lateral guidance all the time, while the system performs the other function within certain limits. In partially automated driving (TAF), the system takes control of the longitudinal and lateral guidance for a certain period of time and/or in specific situations while the driver has to constantly monitor the system, as in assisted driving. In highly automated driving (HAF), the system takes control of the longitudinal and lateral guidance for a certain period of time without the driver having to constantly monitor the system; however, the driver must be in a position to take control of the vehicle within a certain period of time. In fully automated driving (VAF), the system can automatically handle the driving in all situations for a specific application; for this application case a driver is no longer required.

The four automation levels listed above correspond to SAE levels 1 to 4 of the SAE J3016 standard (SAE—Society of Automotive Engineering). For example, highly automated driving (HAF) complies with level 3 of the SAE J3016 standard. In addition, SAE J3016 also provides SAE level 5 as the highest automation level, which is not included in the BASt definition. SAE level 5 is equivalent to driverless driving, in which the system can automatically handle all situations in the same way as a human driver throughout the entire journey; a driver is generally no longer required.

The embodiments of this disclosure preferably refer to SAE Levels 1 to 3, and in particular SAE Level 3.

According to another aspect of this disclosure, a method for a vehicle having a driving assistance system for an automatic drive is specified. The method comprises performing an electrical seat adjustment of a driver's seat during an automatic drive operation of the vehicle; and maintaining the seat setting in a range suitable for allowing the driver to assume control of the vehicle.

The method can implement the aspects of the system described in this document for a vehicle fitted with a driving assistance system for automatic driving. According to a further independent aspect, a software (SW) program is specified. The software program can be configured to be executed on one or more processors and thereby to carry out the method described in this document for a vehicle fitted with a driving assistance system for automatic driving.

According to a further independent aspect, a storage medium is specified. The storage medium can comprise a software program which is configured to be executed on one or more processors and thereby to carry out the method described in this document for a vehicle fitted with a driving assistance system for automatic driving.

### BRIEF DESCRIPTION OF THE DRAWINGS

Exemplary embodiments of the disclosure are shown in the drawings and will be described in more detail in the following.

### Brief Description of the Drawings

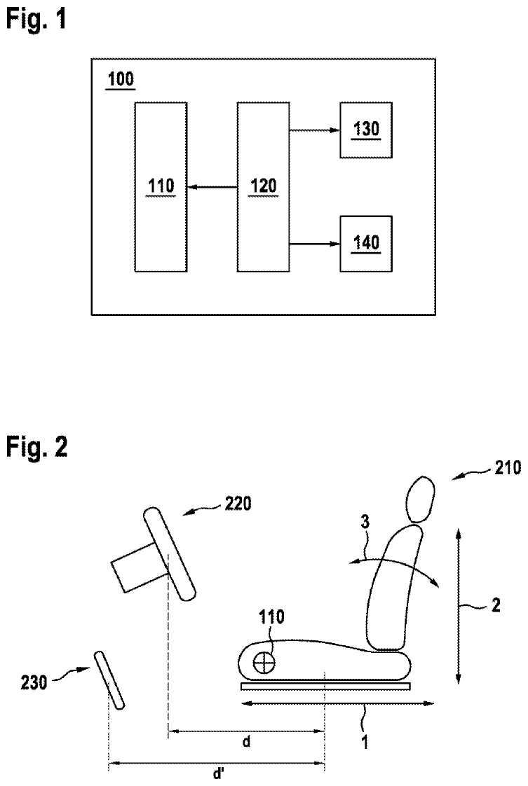

FIG. 1 is a schematic, block diagram of a system for a vehicle equipped with a driving assistance system for automatic driving in accordance with embodiments of this disclosure;

FIG. 2 is a schematic view of a setting of a driver's seat in accordance with embodiments of the present disclosure;

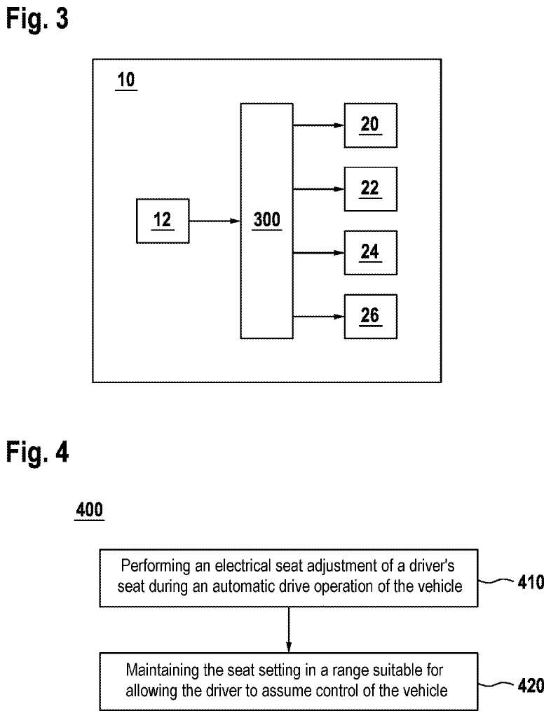

FIG. 3 is a schematic, block diagram of a vehicle equipped with a driving assistance system for automatic driving in accordance with embodiments of the present disclosure; and

FIG. 4 is a flowchart for a vehicle equipped with a driving assistance system for automatic driving in accordance with embodiments of this disclosure.

In the following, unless otherwise noted, the same reference signs are used for identical and equivalent elements.

### DETAILED DESCRIPTION OF THE DRAWINGS

FIG. 1 shows a schematic view of a system 100 for a vehicle having a driving assistance system for automatic driving in accordance with embodiments of this disclosure.

The system 100 comprises an adjustment module 110 for an electrical seat adjustment of a driver's seat; and a control module 120 which is configured to maintain a seat setting of the driver's seat in a range, or limit it to a range, that is suitable for allowing the driver to assume control of the vehicle during an automatic drive operation of the vehicle.

The adjustment module 110 and/or the control module 120 can be implemented in a common software and/or hardware module. Alternatively, the adjustment module 110 and/or the control module 120 can each be implemented in separate software and/or hardware modules.

The control module 120 can be configured to issue an acoustic and/or visual warning if the seat setting of the driver's seat approaches an (outer) limit of the range and/or reaches the (outer) limit. For this purpose, the system 100 can comprise at least one optical output unit 130 and/or at least one loudspeaker unit 140 to issue the warning. For example, the optical output unit 140 can be a display device, such as a display of an infotainment system of the vehicle.

In addition or alternatively, the control module 120 is configured to control the adjustment module 110 during the automatic drive operation of the vehicle in such a way that the seat setting of the driver's seat beyond the safe range is not possible or is prevented. In other words, a (possible) seat setting can be limited to the safe range, so that the driver is unable to move the driver's seat beyond the safe range.

FIG. 2 shows a schematic view of a setting of a driver's seat 210 in accordance with embodiments of the present disclosure.

The adjustment module 110 can be operated by a user to perform the electrical seat adjustment of the driver's seat 210. For example, the adjustment module 110 can comprise at least one control element (e.g., on the seat itself, in the door, or in the center console), which when operated sets at least one motor in motion that moves the driver's seat 210 in the desired direction.

The seat adjustment can comprise at least one (spatial) component. The at least one component of the seat settings can be selected from the group comprising or consisting of a longitudinal position 1, a height position 2, and a backrest position 3 (tilt).

The longitudinal position 1 can be defined based on a distance d between the driver's seat 210 and the steering wheel 220 and/or a distance d′ between the driver's seat 210 and the pedals 230. The reference points for the definition of the distance can be defined as desired or as appropriate. In other words, the reference points in FIG. 2 are only one example.

The height position 2 is defined in the vertical direction. The backrest position 3 is defined as an inclination with respect to the vertical (or horizontal).

The range of seat settings which is suitable for allowing the driver to assume control of the vehicle is defined in such a way that the steering wheel 220 and the pedals 230 are accessible to the driver.

In one example, the range is given by only one component, such as the longitudinal position 1 of the driver's seat 210. In other words, the range can be defined in such a way that a specific longitudinal position of the driver's seat 210 indicates the limit of the range. The specified longitudinal position may correspond to a maximum distance (e.g. the distance d) between the driver's seat 210 and the steering wheel 220 (and/or the pedals 230) at which the driver can safely assume control of the vehicle.

In another example, the range is given by two or more components, such as the longitudinal position 1 and the backrest position 3. In other words, for each component a sub-range of possible/permitted settings may be given, which together form the range of permitted seat settings.

The sub-ranges can be defined independently or depending on one another. In an example with dependent sub-ranges, the sub-range of the longitudinal position 1 can be smaller, the more inclined the backrest position 3. Similarly, the more straight the backrest position 3, the greater the sub-range of the longitudinal position 1 can be. This ensures that the driver can grip the steering wheel 220 with their hands at any time.

In some embodiments, the control module is configured to maintain the seat setting of the driver's seat 210 in the range during the automatic drive operation of the vehicle if the seat setting reaches a threshold or approaches the threshold. For example, the control module can be configured to maintain the driver's seat setting in the range during the automatic drive operation of the vehicle when the seat position reaches a specified threshold in at least one spatial direction (e.g. horizontally, i.e., corresponding to the longitudinal position 2) or approaches the specified threshold. For example, the specified threshold can indicate a maximum permissible (longitudinal) distance between the driver's seat 210 and the steering wheel 220 (e.g. the distance d) and/or the pedals 230 (e.g. the distance d′).

The threshold can be a relative and/or variable threshold. In particular, the threshold can be set individually with reference to the driver. For example, the driver can be detected by means of an interior sensor system such as an interior camera. Based on the data collected, for example, the size of the driver, an arm length, a foot length etc. can be determined and, based on this, the threshold can be defined relatively and/or variably, i.e. individually for the driver.

Alternatively, the threshold can be a fixed threshold. In other words, the threshold can be independent of the individual driver. For example, once the longitudinal position of the driver's seat 210 (x-position) is adjusted beyond a certain value relating to a distance from the driver's seat 210 to the steering wheel 220, the system can become active and issue the warning to the driver and/or restrict the adjustment options of the driver's seat 210.

FIG. 3 shows a schematic view of a vehicle 10 having a driving assistance system 300 for automatic driving in accordance with embodiments of the present disclosure.

The vehicle 10 comprises the driving assistance system 300 for automatic driving. In such automatic driving, the longitudinal and lateral guidance of the vehicle 10 are performed automatically. The driver assistance system 300 therefore assumes control of the vehicle. For this purpose, the driving assistance system 300 controls the drive unit 20, the transmission 22, the hydraulic foot brake 24, and the steering 26 via intermediate units, not shown.

For the planning and implementation of the automatic driving, the driving assistance system 300 receives environmental information from an environment sensor system that monitors the vehicle environment. In particular, the vehicle can comprise at least one environment sensor 12, which is configured to record environmental data indicating the vehicle environment. For example, the at least one environment sensor 12 can comprise one or more LiDAR systems, one or more radar systems, and/or one or more cameras.

FIG. 4 shows a schematic flowchart of a method 400 for a vehicle having a driving assistance system for automatic driving in accordance with embodiments of this disclosure. The method 400 can be implemented by appropriate software that can be executed by one or more processors (e.g. a CPU).

The method 400 comprises, in block 410, performing an electrical seat adjustment of a driver's seat during an automatic drive operation of the vehicle; and in block 420 maintaining the seat setting in a range suitable for allowing the driver to assume control of the vehicle.

According to the invention, the system ensures that the seat setting of the driver's seat remains in a safe range which allows the driver to assume control, or does not impede it or even prevent it. This prevents the driver, for example, from moving their seat during highly automated driving to a position that is no longer ideally suited to allowing the driver to reach the steering wheel or the vehicle pedals.

Thus, an ability to assume control is maintained. In addition, the option of simply locking the seat adjustment during highly automated driving is not taken, thus avoiding a safety risk. By adjusting the seat during or (shortly) before the activation of highly automated driving, a simple locking would deprive the driver of the possibility of moving into a position with the best possible readiness to assume control.

Although the invention has been illustrated and explained in greater detail by means of preferred exemplary embodiments, the invention is not restricted by the examples disclosed and other variations can be derived therefrom by the person skilled in the art without departing from the scope of protection of the invention. It is therefore clear that a wide range of variation options exist. It is also clear that exemplified embodiments really only represent examples which cannot be interpreted in any way as limiting the scope of protection, the range of applications, or the configuration of the invention. On the contrary, the preceding description and the description of the figures enable the person skilled in the art to concretely implement the exemplary embodiments, wherein the person skilled in the art, having knowledge of the disclosed concept of the invention, can make various changes, for example, with regard to the function or arrangement of individual elements mentioned in an exemplary embodiment without departing from the scope of protection, which is defined by the claims and their legal equivalents, such as further explanations in the description.

1.-10. (canceled)

11. A system for a vehicle equipped with a driving assistance system for automatic driving, comprising:
an adjustment module for an electrical seat adjustment of a driver's seat; and
a control module configured to maintain a seat setting of the driver's seat in a range that is suitable for allowing the driver to assume control of the vehicle during an automatic drive operation by the driving assistance system of the vehicle.

12. The system according to claim 11, wherein
the control module is further configured to issue an acoustic and/or visual warning when the seat setting of the driver's seat approaches a limit of the range and/or reaches the limit.

13. The system according to claim 11, wherein
the control module is further configured to control the adjustment module during the automatic drive operation of the vehicle such that a seat setting of the driver's seat beyond the range is not possible.

14. The system according to claim 11, wherein
the range which is suitable for allowing the driver to assume control of the vehicle is specified such that a steering wheel and/or pedals are accessible to the driver.

15. The system according to claim 11, wherein
the control module is further configured to maintain the seat setting of the driver's seat in the range during the automatic drive operation of the vehicle when the seat setting reaches a threshold or approaches the threshold.

16. The system according to claim 15, wherein the threshold is a relative threshold or a fixed threshold.

17. The system according to claim 11, wherein the adjustment module is actuatable by a user in order to carry out the electrical seat setting of the driver's seat.

18. A vehicle motor vehicle comprising the system according to claim 11.

19. A method for a vehicle equipped with a driving assistance system, comprising:
performing an electrical seat adjustment of a driver's seat during an automatic drive operation by the driving assistance system of the vehicle; and
maintaining the seat setting in a range suitable for allowing the driver to assume control of the vehicle.

20. A computer product comprising a non-transitory storage medium having stored thereof a software program which is configured to be executed on one or more processors, to carry out the acts of:
performing an electrical seat adjustment of a driver's seat during an automatic drive operation by the driving assistance system of the vehicle; and
maintaining the seat setting in a range suitable for allowing the driver to assume control of the vehicle.
